(19) United States
(12) Patent Application Publication
(10) Pub. No.: US 2007/0162758 A1
(43) Pub. Date: Jul. 12, 2007

(54) Information processing device, performance controlling method, and operation interface

(76) Inventor: Akira Inoue, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/416,353

(22) Filed: May 1, 2006

(30) Foreign Application Priority Data
Jan. 2, 2006 (JP) 2006-024485

(51) Int. Cl. H04L 9/00

(52) U.S. Cl. 713/178

(57) ABSTRACT

Disclosed is an information processing device including a communication unit to communicate with an external time stamp certification server; and a control unit; wherein the control unit requests a time stamp of subject data to the time stamp certification server through the communication unit, conducts a first processing which stores a time stamp-A obtained and the subject data with relationship in a storing unit in a case where the time stamp-A was obtained successfully, conducts a second processing which is different from the first processing in a case where the time stamp-A was not obtained successfully.

### CROSS-REFERENCE TO RELATED APPLICATION

The present U.S. patent application claims a priority under the Paris Convention of Japanese patent application No. 2006-24485 filed on Feb. 1, 2006, and shall be a basis of correction of an incorrect translation.

### BACKGROUND OF THE INVENTION

1. Field of the Invention

The present invention relates to an information processing device that obtains a time stamp of object data, a performance controlling method during obtainment of the time stamp, and an operation interface to conduct operation relating to such performance control.

2. Description of Related Art

Concerning information processing device such as a printer, a copying machine, a facsimile device, and a complex machine of these, there are devices that have structure provided with hard disk (HD), capable of storing electronic data that is subject to output. Regarding such structure, information processing device that can apply a time stamp in order to prevent falsification of the stored data is developed. (For example, refer to Japanese Laid-Open Patent Publication No. 2005-151358)

By applying the time stamp, it can be proved from when the stored data had existed, or whether no falsification was conducted. Therefore, reliability of the stored data can be maintained. A time stamp is obtained by calculating hash value of the stored data, and requesting a time stamp by sending this hash value to a server at a time stamp certificate authority.

However, there may be an occasion in which a time stamp cannot be obtained successfully, such as (1) an error occurs to the communication line with the time stamp certification server and the time stamp cannot be obtained, (2) long time is required to obtain the time stamp, or (3) the time stamp was able to obtain but the time stamp itself has defection. In the method disclosed in the aforementioned patent document, the above mentioned occasions of (1) through (3) are not taken in consideration, and therefore no efficient countermeasure is taken for the stored data. As a result, the stored data may be subject to falsification and the like during that period, and reliability of the stored data is lost.

### SUMMARY

The present invention has been made to solve the above problems. An object of the present invention is to prevent the subject data from being treated in the same manner as in a case where a time stamp was obtained successfully, in a case where the time stamp was not obtained successfully.

Before advancing further, some terminologies used in this specification are explained. In this specification, a terminology “time stamp” may mean a time stamp in general, “time stamp-A” means an exact time stamp that was obtained in responsive to a first one of time stamp requests, and “time stamp-B” means an exact time stamp that was obtained in responsive to any one of a second to n-th time stamp requests.

In order to achieve the above object, according to an embodiment reflecting one aspect of the present invention, an information processing device comprises: a communication unit to communicate with an external time stamp certification server; and a control unit; wherein the control unit requests a time stamp of subject data to the time stamp certification server through the communication unit, conducts a first processing which stores a time stamp-A obtained in association with the subject data in a storing unit in a case where the time stamp-A was obtained successfully, and conducts a second processing which is different from the first processing in a case where the time stamp-A was not obtained successfully.

Preferably, the storing unit stores the subject data in advance; and the control unit eliminates or erases the subject data from the storing unit as a performance content of the second processing.

Preferably, the storing unit stores the subject data in advance; and the control unit eliminates or erases the subject data from the storing unit in a case where a time stamp-B was not obtained successfully as a result of requiring a time stamp again to the time stamp certification server, as a performance content of the second processing.

Preferably, the information processing device further comprises an operation unit which is capable of being operated by a user; wherein: the number of times to re-request a time stamp is set through the operation unit; and the control unit eliminates the subject data from the storing unit in the case where the time stamp-B was not obtained successfully as a result of re-requiring a time stamp within the number of times set through the operation unit.

Preferably, the information processing device further comprises an operation unit which is capable of being operated by a user; wherein: the control unit provides an operation screen to the operation unit to let the user set performance content to be executed to the subject data, when the time stamp-A was not obtained successfully, as a performance content of the second processing.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a view showing a certification system including an information processing device of the present embodiment;

FIG. 2 is a view showing inner structure of the information processing device;

FIG. 3 is a view showing an example of setting screen to set performance executed in a case where a time stamp was not obtained successfully;

FIG. 4 is a flowchart showing a first certification processing executed by the information processing device;

FIG. 5 is a flowchart showing a second certification processing executed by the information processing device;

FIG. 6 is a flowchart showing a third certification processing executed by the information processing device; and

FIG. 7 is a view showing an example of setting screen when setting performance again.

### DETAILED DESCRIPTION OF THE PREFERRED EMBODIMENTS

An embodiment relating to the information processing device, the performance controlling method, and the operation interface of the present invention will be described below with reference to figures.

First of all, structure is described.

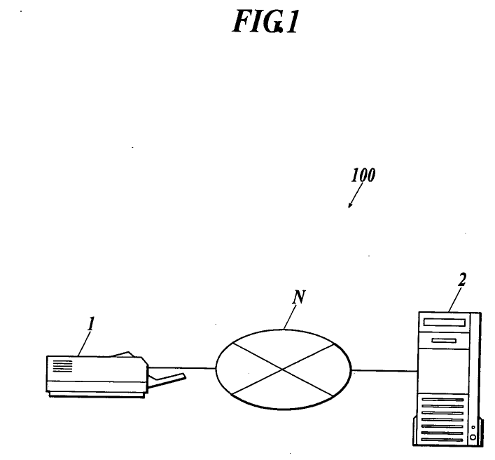

FIG. 1 shows a certification system 100 including an information processing device 1 of the present embodiment.

As shown in FIG. 1, the certification system 100 is structured with multi-functional peripheral (MFP) 1 as an information processing device and a time stamp certification server 2. Each of the devices 1 and 2 are connected through network N such as internet and the like.

The certification system 100 is a system in which the time stamp certification server 2 issues a time stamp according to request from MFP 1.

The MFP 1 is a device provided with a plurality of functions such as a copying machine, a scanner, a printer, and the like. MFP 1 can conduct print output according to subject data, which is subject to obtaining a time stamp. Here, the subject data typically includes image data read by the scanner function, and image data or print data sent from a user terminal (not shown) to a printer. Alternatively, the subject data may be print job, or print job ticket.

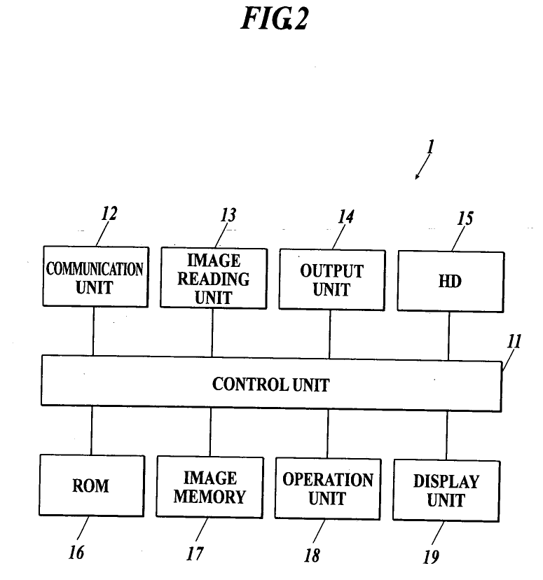

FIG. 2 shows an internal structure of the MFP 1.

As shown in FIG. 2, MFP 1 is structured with control unit 11, communication unit 12, image reading unit 13, output unit 14, HD 15, read only memory (ROM) 16, image memory 17, operation unit 18, display unit 19, and the like.

The control unit 11 is structured with central processing unit (CPU), random access memory (RAM), and the like. Various kinds of control programs, processing programs, and the like stored in the ROM 16 are spread out to the RAM, and either calculation is conducted, or performances of each units of 12 through 18 are controlled in a central control manner, by CPU according to these programs.

The communication unit 12 is provided with interface for communication, such as network interface and the like, communicates with the time stamp certification server 2 through network N, communicates with user terminal and the like that are not shown, and receives subject data.

The image reading unit 13 reads image on a document and generates image data of the document. The image reading unit 13 is structured with a mirror set, an image pickup device such as charge coupled device (CCD) image sensor, and the like. The mirror set has a unit structure of a light source to irradiate light to the document subject to reading, and a mirror to reflect the reflected light from the document to incident into the image pickup device.

When reading an image, mirror unit is scanned with respect to the document to irradiate light onto the surface of the document, and conducts photoelectric conversion by receiving reflected light with the image pickup device. An image signal (analog) generated by photoelectric conversion is A/D converted at a signal processing unit not shown, and after being temporally stored in the image memory 17, is outputted to output unit 14 or HD 15 under control of the control unit 11.

The output unit 14 conducts print output according to object data inputted from the control unit 11. Type of printing, concerning the output unit 14, may be any type among electrophotographic type, inkjet type, or the like. To give a description for type of printing by taking electrophotographic type for example, the output unit 14 is provided with an exposing unit, a developing unit, a fixing unit, and the like. When conducting print output, an electrostatic latent image according to data subject to output is formed on a photoconductive member by the exposing unit, and a toner is sprayed onto the printing sheet by the developing unit. The photoconductive member applied with the toner is transferred to an image receiving sheet, such as a paper, and the image receiving sheet is heated at the fixing unit, and fix processing of the toner is applied, then outputted.

The HD 15 is a large capacity memory to store subject data, and the like. Here, in place of the HD 15, a memory which is detachable to the MFP 1 can be also used.

The ROM 16 stores various kinds of control programs and processing programs executed by the control unit 11, parameters and data required to execute the programs, and the like.

The image memory 17 is a memory to temporally store subject data.

The operation unit 18 is provided with various kinds of functional buttons such as a button to instruct printing, buttons to set printing conditions, and the like; and a touch panel (operation panel) that is structured in combination with the display unit 19. The operation unit 18 generates operation signal corresponding to the depressed button, and outputs the signal to the control unit 11.

The display unit 19 is provided with a display panel such as liquid crystal display (LCD) and the like, and displays various kinds of operation screens such as a print setting screen and a dialog screen to set function, processing result of the control unit 11, and the like.

The time stamp certification server 2 is a time-stamping authority (TSA) that receives time data from a time authority (TA), which times accurate time with compliance to the standard, and issues a time stamp according to this time data. When the time stamp certification server 2 receives from the MFP 1, a hash value of the subject data which is subject to certification by a time stamp, the time stamp certification server 2 obtains time data from the time authority, encrypts the time data and hash value by using a secret key provided to the time stamp certification server 2, and sends them to the MFP 1 as the time stamp.

Next, performance will be described.

At the MFP 1, when there is an instructing operation to store in the HD 15 data subject to output, a time stamp for the subject data is obtained and data thereof is attached to the data subject to output, in order to maintain reliability of the subject data. Alternatively, when there is an instructing operation to attach the time stamp to the data subject to output, the time stamp is obtained and attached in a similar manner. Meantime, when the time stamp was not obtained successfully, a set performance is executed to the subject data.

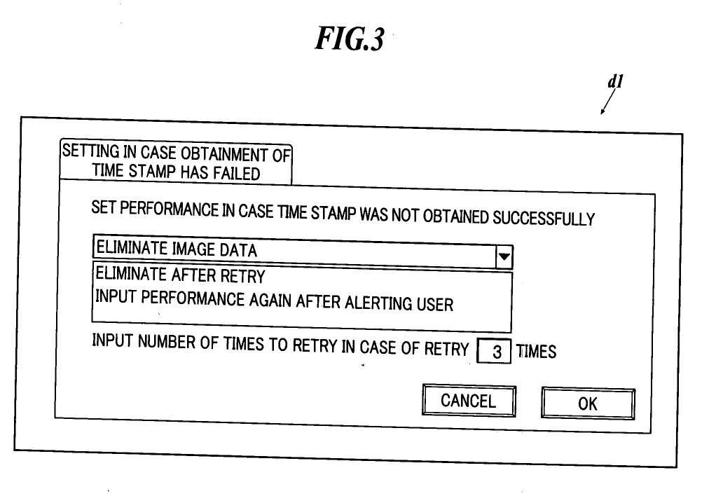

Setting of performance is conducted in prior to requesting a time stamp, by a dialog screen d1 displayed on the display unit 19, as shown in FIG. 3.

The dialog screen d1 is a setting screen that a user can select a performance to be executed to subject data, in the case where a time stamp-A was not obtained successfully. In the dialog screen d1, three performances are displayed selectively, that is, (1) elimination of image data (data subject to output), (2) elimination of image data after execution of retry (re-request), and (3) requiring input of next performance after alerting a user that obtainment has failed. Concerning the performance (2), the number of times to retry can be set, and an input area for the number of times to retry is provided. Here, as an initial value for the number of times to retry, “1” can be set, or this initial value may not be displayed in the input area. Therefore, in a case where the user does not set the number of times to retry, processing is conducted with this initial value as the number of times to retry.

The user chooses any one of the performances of the aforementioned (1) to (3) through the operation unit 18, inputs the number of times to retry when performance (2) is chosen, and operates OK button.

In the MFP 1, setting data of the performance chosen as the performance in the case where the time stamp-A was not obtained successfully, is stored in the RAM of the control unit 11.

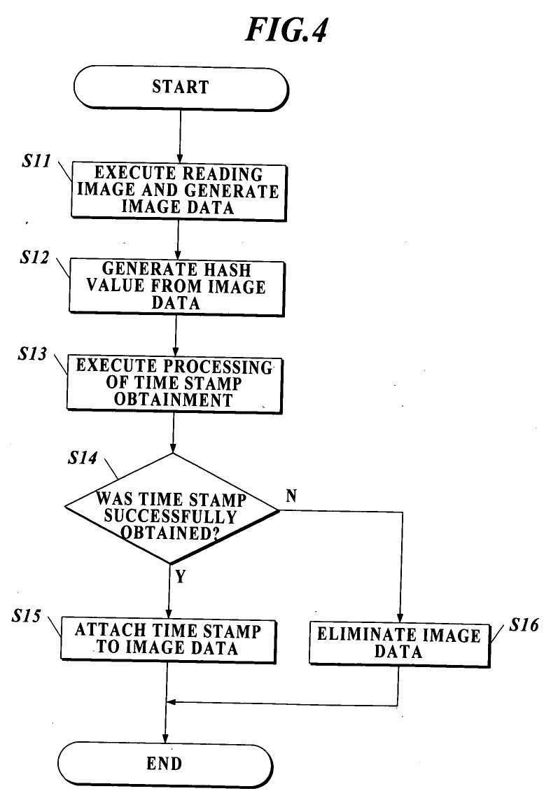

Next, processing executed at the MFP 1 when the time stamp is obtained, according to the settings of the aforementioned (1) to (3), is described with reference to FIGS. 4 to 6. Here, in the following description, an example in a case where data subject to output is obtained by the image reading unit 13, and the time stamp is attached when the data is stored in the HD 15, is mentioned.

FIG. 4 is a flowchart showing a first certification processing executed when the settings of aforementioned (1) is conducted.

In the first certification processing shown in FIG. 4, first of all, image reading of the image on the document is executed by the image reading unit 13, and its image data is generated (step S11). The generated image data is stored in the HD 15 under control of control unit 11.

Subsequently, in the control unit 11, by calculation using hash function, hash value is generated from the image data stored in the HD 15 (step S12). Processing to obtain a time stamp is then executed at the control unit 11 by the hash value generated (step S13). In the processing to obtain a time stamp, request data to request issue of a time stamp accompanied with data of hash value is sent to the time stamp certification server 2 through communication unit 12.

After execution of processing to obtain a time stamp, the control unit 11 determines whether the time stamp-A was obtained successfully or not (step S14). For example, in cases where the time stamp is not received after a predetermined time has elapsed, data received has defect, the data is in a form that is not standardized by the time stamp certification server 2, or the like, it is determined that the time stamp was not obtained successfully.

When it is determined that the time stamp-A was obtained successfully (step S14; Y), data of the time stamp-A obtained by the control unit 11 is attached to the image data. Image data attached with the time stamp-A is updated and stored in the HD 15 (step S15).

Meantime, when the time stamp-A was not obtained successfully (step S14; N), image data is eliminated from the HD 15 (step S16), and the processing is completed.

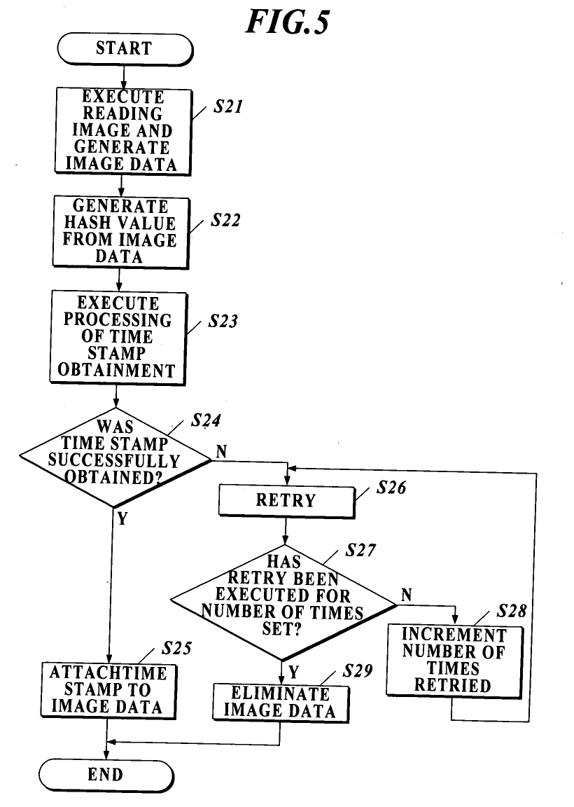

Next, the second certification process executed by the MFP 1 in a case where the job (2), eliminate after execution of retry (re-request) is set, is described with reference to FIG. 5.

In the second certification process described in FIG. 5, in a similar manner to the first certification process, image reading of the image on the document is executed by the image reading unit 13, and its image data is generated (step S21). The generated image data is stored in the HD 15 under control of control unit 11.

Subsequently, in the control unit 11, hash value is generated from the image data stored in the HD 15 (step S22). Processing to obtain a time stamp is then executed at the control unit 11 by the hash value generated (step S23). The control unit 11 determines whether the time stamp-A was obtained successfully or not (step S24).

When it is determined that the time stamp-A was obtained successfully (step S24; Y), data of the time stamp-A obtained by the control unit 11 is attached to the image data. Image data attached with the time stamp-A is updated and stored in the HD 15 (step S25).

Meantime, when the time stamp-A was not obtained successfully (step S24; N), processing to obtain a time stamp is executed again (retry) at the control unit 11 (step S26). At the control unit 11, the number of times retry has been conducted is counted. In the initial settings, the count value is set to “0”. After retry, count value for the number of times retry has been conducted is referred, and it is determined whether processing to obtain a time stamp has been executed for the number of times to retry which has been set (step S27).

When processing to obtain a time stamp is not executed for the number of times to retry which has been set (step S27; N), the number of times retry has been conducted is incremented by one at the control unit 11 (step S28), and moves on to processing of step S26. That is, processing to obtain time stamp is repeated until it is executed for the number of times to retry which has been set.

Meantime, when processing to obtain time stamp is executed for the number of times to retry which has been set (step S27; Y), image data stored in the HD 15 is eliminated by the control unit 11 (step S29), and the processing is completed.

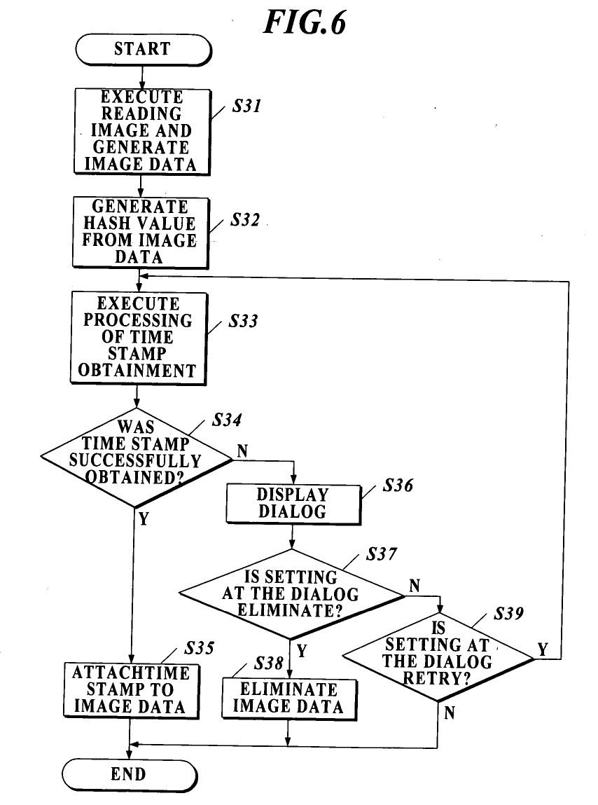

Next, the third certification process executed by the MFP 1 in a case where the job (3), requesting input of next performance after alerting the user is set, is described with reference to FIG. 6.

In the third certification process described in FIG. 6, in a similar manner to the first certification process, image reading of the image of the document is executed by the image reading unit 13, and its image data is generated (step S31). The generated image data is stored in the HD 15 by the control unit 11.

In the control unit 11, hash value is generated from the image data stored in the HD 15 (step S32). Processing to obtain time stamp is then executed at the control unit 11 by the hash value generated (step S33). Subsequently, the control unit 11 determines whether the time stamp-A was obtained successfully or not (step S34).

When it is determined that the time stamp-A was obtained successfully (step S34; Y), data of the time stamp-A obtained by the control unit 11 is attached to the image data. Image data attached with the time stamp-A is updated and stored in the HD 15 (step S35).

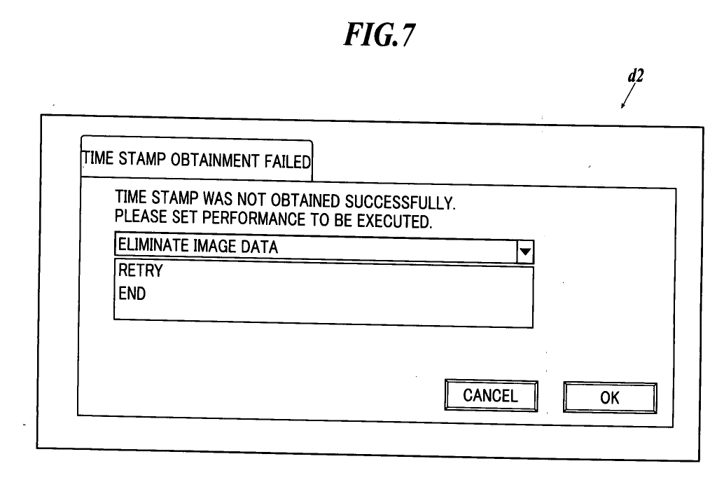

Meantime, when the time stamp-A was not obtained successfully (step S34; N), processing to set operation is conducted under control of the control unit 11. In the processing to set operation, a dialog screen d2 is displayed on the display unit 19, as in FIG. 7 (step S36), and setting operation for the performance is conducted again. The dialog screen d2 is a setting screen to set performance, and as shown in FIG. 7, along with a message to alert the user that the time stamp was not obtained successfully, three performances are displayed selectively, that is, (3-1) elimination of image data, (3-2) retry, and (3-3) completion of processing with no further performance. Here, if the performance (3-3), completing the processing, is unfavorable concerning security of the data subject to output, this option may be omitted.

The user selectively operates any one of the aforementioned performances (3-1) to (3-3), through the operation unit 18.

At the MFP 1, when a selective operation through the operation unit 18 is detected by the control unit 11, it is determined whether the performance selectively set is the aforementioned (3-1), eliminating image data, or not (step S37). In a case where it is the performance to eliminate (step S37; Y), the image data stored in the HD 15 is eliminated by the control unit 11 (step S38).

Meantime, when the selectively set performance is not the performance to eliminate (step S37; N), but is the performance (3-2), retry (step S39; Y), it moves on to the processing of step S33, and the processing to obtain a time stamp is executed again.

Additionally, when the selectively set performance is (3-3), completion of the processing (step S39; N), the processing is completed within a status in which the image data is stored in the HD 15. The image data stored in the HD 15 is print outputted, or sent to a user terminal and the like, according to later operations.

As described, according to the present embodiment, since a processing that is different from the processing which is conducted in a case where the time stamp was obtained successfully, is executed in a case where the time stamp was not obtained successfully, a handling different from that in the case where the time stamp was obtained successfully can be applied to the subject data. Therefore, the subject data can be prevented in advance from being handled as if the time stamp was attached, even though reliability is not maintained by a successful time stamp.

That is, since a performance set to image data ((1) elimination of image data, (2) elimination of image data after retry, (3) requesting input of next performance) is executed in the case where the time stamp-A was not obtained successfully, the image data is prevented from being left unattended even in the case where the time stamp-A was not obtained successfully. As a result, prevention of fraudulent processing, such as falsification and the like, to image data with such high importance that a time stamp certification is required, can be achieved.

Since the aforementioned performances can be selectively set by a user, performance in accordance with an object of the user can be executed. In addition, performance in the case where the time stamp-A was not obtained successfully can be set in prior to requiring a time stamp.

As for performance, any one among: (1) elimination of image data, (2) elimination of image data after retrying processing to obtain a time stamp, or (3) requesting input of next performance again, is selectively operated. Therefore, setting can be conducted by an easy operation such as selecting from a plurality of operation contents.

In a case where elimination of image data is selected, image data is eliminated when the time stamp-A was not obtained successfully, and in a case where retry is selected, image data is eliminated after processing to obtain a time stamp is conducted again. Therefore, circumstances in which a successful time stamp cannot be obtained for temporally reason, can be managed.

In addition, the number of times to retry can be set, and repeating unnecessary obtainment of a time stamp can be prevented.

In a case where requesting input of next performance is selected, a dialog screen to set again is displayed, and a performance selected in this dialog screen is executed. Therefore, performance depending on each situation can be set when obtainment of the time stamp-A has failed.

Here, in the aforementioned description, an example in which a time stamp is attached to image data read by the image reading unit 13 was described, however, similar processing is executed when attaching a time stamp to text data, image data, or the like, received from a user terminal. In this case, dialog screen (refer to FIGS. 3 and 7) and the like to conduct performance setting is displayed on a display unit of the user terminal by software of printer driver and the like, and information obtained by conducting setting operation at operation unit of the user terminal is sent to the MFP 1.

Additionally, when obtaining data subject to output from the user terminal, hash value may not be generated at the MFP 1 side. The hash value may be generated at the user terminal side, and be received by the MFP 1 along with the data subject to output.

What is claimed is:

1. An information processing device comprising:
a communication unit to communicate with an external time stamp certification server; and
a control unit; wherein
the control unit requests a time stamp of subject data to the time stamp certification server through the communication unit, conducts a first processing which stores a time stamp-A obtained in association with the subject data in a storing unit in a case where the time stamp-A was obtained successfully, and conducts a second processing which is different from the first processing in a case where the time stamp-A was not obtained successfully.

2. The information processing device of claim 1, wherein:
the storing unit stores the subject data in advance; and
the control unit eliminates the subject data from the storing unit as a performance content of the second processing.

3. The information processing device of claim 1, wherein:
the storing unit stores the subject data in advance; and
the control unit eliminates the subject data from the storing unit in a case where a time stamp-B was not obtained successfully as a result of requesting a time stamp again to the time stamp certification server, as a performance content of the second processing.

4. The information processing device of claim 3, further comprising:
an operation unit which is capable of being operated by a user; wherein:
the number of times to request a time stamp is set through the operation unit; and
the control unit eliminates the subject data from the storing unit in the case where the time stamp-B was not obtained successfully as a result of re-requesting a time stamp within the number of times set through the operation unit.

5. The information processing device of claim 1, further comprising:
an operation unit which is capable of being operated by a user; wherein:
the control unit provides an operation screen to the operation unit to let the user set performance content to be executed to the subject data, when the time stamp-A was not obtained successfully, as a performance content of the second processing.

6. The information processing device of claim 1, further comprising an operation unit for a user to set performance content of the second processing.

7. The information processing device of claim 6, wherein:
the performance content of the second processing is selectively set among a plurality of performance contents through the operation unit; and
the control unit sets the performance content selected through the operation unit as the second processing.

8. A performance controlling method comprising:
a requesting step to require a time stamp of subject data to an external time stamp certification server;
a performance controlling step to selectively execute either one among a first processing, which stores a time stamp-A obtained in association with the subject data in a storing unit in a case where the time stamp-A was obtained successfully, or a second processing, which is executed in a case where the time stamp-A was not obtained successfully.

9. The performance controlling method of claim 8,
wherein:
the storing unit stores the subject data in advance; and
at the performance controlling step, the subject data is eliminated from the storing unit as a performance content of the second processing.

10. The performance controlling method of claim 8, wherein:
the storing unit stores the subject data in advance; and
at the performance controlling step, the subject data is eliminated from the storing unit in a case where a time stamp-B was not obtained successfully as a result of requesting a time stamp again to the time stamp certification server, as a performance content of the second processing.

11. The performance controlling method of claim 10, further comprising:
a first setting step to set the number of times to re-request a time stamp; wherein:
at the performance controlling step, the subject data is eliminated from the storing unit in the case where the time stamp-B was not obtained successfully as a result of re-requesting a time stamp within the number of times set at the first setting step.

12. The performance controlling method of claim 8, wherein at the performance controlling step, an operation screen is provided to an operation unit to let a user set performance content to be executed to the subject data, when the time stamp-A was not obtained successfully, as a performance content of the second processing.

13. The performance controlling method of claim 8, further comprising:
a second setting step to set performance content of the second processing according to a setting operation by an operation unit.

14. The performance controlling method of claim 13, wherein:
the performance content of the second processing is selectively set among a plurality of performance contents at the second setting step; and
the performance content selectively set at the second setting step as the second processing is executed at the performance controlling step.

15. An operation interface comprising:
a display unit to display a setting screen to set performance to be executed to subject data in a case where a time stamp-A for the subject data was not obtained successfully from a time stamp certification server, in prior to requesting a time stamp to the time stamp certification server; and
an operation unit to conduct setting operation of the performance to be executed to the subject data in the setting screen.

16. The operation interface of claim 15, wherein the display unit displays at least one of performance contents of (1) elimination of the subject data, (2) requesting a time stamp again, and (3) selection of a performance to be executed to the subject data when the time stamp-A was not obtained successfully, as performance content executed to the subject data in the setting screen.

17. The operation interface of claim 16, wherein the display unit displays a plurality of performance contents including at least the performance contents (1) through (3), so as to be capable of being selectively set.

18. The operation interface of claim 17, wherein the display unit, concerning the performance content (2), displays a display content to set a number times to re-require a time stamp.
